(19) United States
(12) Patent Application Publication
(10) Pub. No.: US 2009/0194693 A1
(43) Pub. Date: Aug. 6, 2009

(54) Imaging Apparatus for Combined Temperature and Luminescence Spatial Imaging of an Object

(75) Inventors: Derk Jan Wilfred Klunder, Eindhoven (NL); Aleksey Kolesnychenko, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/301,642

(22) PCT Filed: May 14, 2007
(86) PCT No.: PCT/IB2007/051813

§ 371 Date: Nov. 20, 2008

(30) Foreign Application Priority Data
May 24, 2006 (EP) 06114486.1

(51) Int. Cl. G01N 21/64; G01N 21/76

(52) U.S. Cl. 250/332; 250/458.1; 250/208.1

(57) ABSTRACT

An imaging apparatus is disclosed for combined temperature and luminescence spatial imaging of an object (1), such as a bio-array for detection of biological molecules. Light (5) is separated into a first (10) and a second (20) optical path, where the first optical path (10) guides infrared (IR), and the second optical path (20) guides luminescence light, preferably fluorescence light, from the object (1). Image intensifying means (30) converts infrared light (10a) in the first optical path into intensified light (10b), preferably visible light. Photo detection means (100) are arranged for spatial imaging of the object (1), the photo detection means being arranged for alternately receiving light from the first (10) and the second (20) optical path. Processing means (200) are capable of combining a temperature image (11) with a luminescence image (21) so as to obtain a combined image (25) of the object with a direct spatial correspondence between the two images. For bio-arrays this provides many advantages in relation to combined imaging of an array, whereupon numerous probe molecules are located.

### FIELD OF THE INVENTION

The present invention relates to an imaging apparatus for combined temperature and luminescence spatial imaging of an associated object such as a bio-array for detection of biological molecules. The invention also relates to a biological detection system comprising an imaging apparatus according to the invention. The present invention further relates to a method for combined temperature and luminescence spatial imaging.

### BACKGROUND OF THE INVENTION

Detection methods for particular biological molecules such as nucleic acids are manifold and many different approaches are presently available to the skilled person. The detection of specific nucleic acids or groups of nucleic acids has a range of important practical applications, including gene identification for diagnostic purposes.

In general, the detection of biological specimen (the “target”) such as polynucleotides, DNA, RNA, cells, and antibodies can especially be performed on a so-called bio-array (or micro-array) whereupon corresponding probe molecules are attached at various sites on the test array. Target-probe examples are DNA/RNA-oligonucleotide, antibody-antigen, cell-antibody/protein, hormone receptor-hormone, etc. When the target is bound or hybridised to a corresponding probe molecule detection of the target bio-molecule may be performed by a variety of optical, electronic and even micromechanical methods, see e.g. U.S. Pat. No. 5,846,708. Such bio-arrays are now commonly applied in the area of biochemistry.

An important parameter for the binding or hybridization between the target and probe molecule is the local temperature on the bio-array.

Firstly, if the target molecule is a double-stranded nucleic acid, a so-called denaturing process separating the two opposite strands may be needed. Denaturing may e.g. be accomplished by raising the temperature of sample containing the target molecule.

Secondly, many relevant bio-molecules exhibit a certain degree of non-specific bonding or hybridization which in turn limits the specificity of the assays performed using the bio-array. This may be avoided or reduced by setting the local temperature on the bio-array just below the melting temperature of a specific target molecule in order to discriminate non-target molecules.

Thirdly, the hybridization process itself is controlled by binding kinetics that is typically highly dependent on temperature. Correct interpretation of the hybridization, in particular the quantitative assessment of such bindings, therefore requires precise control of the temperature on the bio-array.

For these and other reasons, a precise and fast temperature measurement is highly important on a bio-array. However, temperature measurements on the bio-array will seldomly provide sufficient information about the binding processes even though some binding events may evolve heat and in turn raise the local temperature on the bio-array. See for example US patent application 2004/0180369, where infrared thermography is applied in combination with surface plasmons in nanoparticles attached to target molecules.

A commonly used technique for detection of molecular binding on bio-arrays is optical detection of fluorescent labeled probes also known as a “label”. In general, a label may be any agent that is detectable with respect to its physical distribution and/or the intensity of the outgoing signal it gives. Fluorescent agents are widely used, but alternatives include phosphorescent agents, electroluminescent agents, chemiluminescent agents, bioluminescent agents, etc.

Typically, for DNA sequence analysis applications a base specific fluorescent dye is bound covalently to the oligonucleotide primer or the chain-terminating dideoxynucleotides used in conjunction with DNA polymerase. The dye is excited by incident light of an appropriate wavelength and subsequently emission of fluorescent light is observed for monitoring the fluorescent labeled receptors. Dyes such as for example ethidium bromide may further exhibit a significant increase in fluorescence when present in duplexed DNA or RNA. Thus, such dyes may be used for indicating hybridization on the bio-array.

However, the optical image provided by the above-mentioned fluorescence method has the disadvantage that it is difficult to combine a fluorescence image with relevant temperature data provided by e.g. infrared thermography or other kinds of temperature imaging in a biologically relevant temperature interval. This is generally known in optical imaging as the correlation problem. Typically, this is done by matching images from the two sources which may lead to incorrect matching considering the micrometer scale of resolution for some fluorescence and/or temperature images, and because of the fact that often the temperature image has no fluorescence components, and vice-versa that the fluorescent image of the object contains no or very limited information related to the temperature of the object.

Hence, an improved luminescence and temperature imaging apparatus would be advantageous, and in particular a more efficient and/or reliable imaging apparatus would be advantageous.

### SUMMARY OF THE INVENTION

Accordingly, the invention preferably seeks to mitigate, alleviate or eliminate one or more of the above-mentioned disadvantages singly or in any combination. In particular, it may be seen as an object of the present invention to provide an imaging apparatus that solves the above-mentioned problems of the prior art with combined temperature and luminescence imaging of an object.

This object and several other objects are obtained in a first aspect of the invention by providing an imaging apparatus for obtaining a combined temperature and luminescence spatial image of an associated object, the apparatus comprising:

optical separating means for separating light received from the object into a first and a second optical path, said first optical path arranged for guiding infrared (IR) portions of the received light from the object, said second optical path being arranged for guiding luminescence portions of received light from the object,

image intensifying means capable of converting infrared light portions of the light in the first optical path into intensified light,

photo detection means arranged for spatial imaging of the object, said photo detection means being arranged for alternately receiving light from the first and the second optical path, and

processing means operably connected to the photo detection means, said processing means being adapted to obtain a spatial temperature image of the object from the intensified light of the first optical path, said processing means further being adapted to spatially combine at least partly said temperature image with a luminescence image of the object obtained from the second optical path so as to obtain a combined image of the object.

The invention is particularly, but not exclusively, advantageous for providing a more simplified apparatus due to the fact that the temperature image and luminescence images of the object is obtainable from the same photo detection means. This in turn reduces the cost of an imaging apparatus according to the present invention.

Furthermore, the present invention may facilitate hitherto unforeseen possibilities for combination of temperature images with corresponding luminescence images of the same object. Particularly, for bio-arrays this provides many advantages in relation to combined imaging of an array, whereupon numerous probe molecules are located.

If the resolution of such images is on the order of micrometer or less, it may be quite time consuming and/or troublesome to combine or match such images manually or even with computers. This is however avoided with the present invention.

In the context of the present invention, the term “infrared (IR) light” is to be understood in a broad sense as the portion of the electromagnetic spectrum from the red end of the visible light range to the microwave region. Thus, the infrared portion of the light may be defined as the wavelength range from 0.65-1500 micrometers (my), preferably 0.70-1200 micrometers, and more preferably 0.75-1000 micrometers. In particular, the infrared portion of light may be defined as light having an upper wavelength of 1000, 1200, or 1500 micrometers. Alternatively, the infrared portion of light may be defined as light having a lower wavelength of 0.65, 0.70 or 0.75 micrometers. For temperature measurements in particular, relevant wavelength intervals may be 1-30 micrometers, 2-20 micrometers, and 3-10 micrometers.

Preferably, said combined image of the object may comprise both luminescence data and temperature data about the object if data of either type has not been discarded as e.g. a result of analysis of said data.

The luminescence portion of received light from the object comprises light may be selected from the group consisting of: photoluminescence, electroluminescence, chemiluminescence and bioluminescence. In particular, the photoluminescence portion of received light may be fluorescence or phosphorescence.

In the context of the present invention, the term “fluorescence” is to be understood in a broad sense as the emitted light resulting from a process where light has been absorbed at a certain wavelength by a molecule or atom, and subsequently emitted at a longer wavelength after a short time known as the fluorescence lifetime of the molecule/atom in question. The emitted light is often, but need not be limited to, in the visible light spectrum (VIS), the ultraviolet spectrum (UV), and the infrared spectrum (IR).

As a special type of fluorescent light anti-Stokes shift may also be mentioned. This kind of fluorescence has a shorter emitted wavelength (i.e. higher energy) than the absorbed wavelength due to coupling with vibrations of the emitting molecule.

Phosphorous light differs from fluorescent light by a relatively long fluorescence lifetime in the order of milliseconds to hundreds of seconds. This is magnitudes above the fluorescence lifetime being in the order of nanoseconds to hundreds of nanoseconds. This short lifetime is a result of the direct energy transition in the Jablonski energy diagram and the selection rules governing such energy transitions in the molecule/atom.

The present invention may find application in embodiments where a chemical reaction results in direct luminescence, i.e. chemiluminescence. Thus, there may be no previous absorption of light. Specifically, the chemical reaction may be catalyzed by an enzyme and accordingly the luminescence is known as bioluminescence.

Beneficially, the photo detection means may be a single photo detection entity so as to provide a direct spatial correspondence between the temperature image and luminescence image obtained from the object. Thus, the photo detection means may advantageously be a single charge coupled device (CCD). Other alternatives may include infrared heat-sensitive arrays of platinum silicide and iridium silicide, but in general any kind of photoconductor, photo diode, and avalanche photo diode may be applied.

In one embodiment of the invention, the optical separating means may comprise a displaceable mirror, possibly more displaceable mirrors. The mirrors may be rotatable displaceable mirrors and linearly displaceable mirrors, and any combination thereof.

Preferably, a displaceable mirror may be displaceable to a first position for guiding the light received from the object into the first optical path, and a second position for guiding the light received from the object into the second optical path. Thus, the apparatus may be operated by switching between a first and second position for obtaining the temperature image and the luminescence image.

In another embodiment, the optical separating means may comprise at least one optical component capable of splitting the light received from the object into an infrared (IR) portion and a luminescence portion, and redirecting the two portions into the first and the second optical path, respectively. The component may be optical components such as prisms, gratings, dichromatic mirrors, etc.

The image intensifying means may be capable of wavelength down-converting the infrared (IR) light, i.e. increasing the energy of the light. Preferably, the image intensifying means may be capable of converting the infrared (IR) light into visible light (VIS) as visible light is optically easier to detect than IR light.

In one embodiment, the first optical path may comprise one or more optical band-pass filters so as to enable local temperature measurement on the object. This may be done by knowing, estimating, or measuring the emissitivity of the object, and then measuring the radiation at a wavelength through said optical filter. Some relevant band pass ranges intervals may include 1-12 micrometers, preferably 1-11 micrometers or more preferably 3-7 micrometers.

In an alternative embodiment, the first optical path may comprise at least a first and a second optical band-pass filter, wherein said first and second band-pass filters have different band-pass ranges.

Preferably, a temperature spatial image may be obtained by combining data obtained from light having passed said first optical band-pass filter with data obtained from light having passed said second optical band-pass filter. Preferably, the first and second optical band-pass filters do not have overlapping band-pass ranges so as to facilitate a two-wavelength approach for obtaining a temperature image of the object.

Preferably, the object for combined imaging may be a bio-array. Preferably, the bio-array may be arranged for analysis of biological targets such as polynucleotides, DNA, RNA, cells, and antibodies. Typically, the bio-array may comprise a plurality of spots, wherein probe molecules are immobilized. In this context, a spot is to be understood as an area having a certain extension. The spot may even have a 3-dimensional configuration if the array has a non-planar surface. In the latter case, a projected area may be defined when referring to e.g. spot density on the array. The bio-array may comprise a silicon wafer, a glass plate, or a porous membrane.

In a second aspect, the present invention relates to a biological detection system for detecting the presence, and optionally quantity, of one or more biological targets, wherein the system comprises an imaging apparatus according to the first aspect of the invention. The system may detect targets that include, but are not limited to, polynucleotides, DNA, RNA, cells, and antibodies. Biological detection systems are often highly complicated and the present invention is advantageous in providing a simplified biological detection system due to the easier and/or faster data analysis obtained by the present invention.

In a third aspect, the present invention relates to a method for obtaining a combined temperature and luminescence spatial image of an object, the method comprising the steps of:

separating light received from the object into a first and a second optical path, said first optical path arranged for guiding infrared (IR) portions of the received light from the object, said second optical path being arranged for guiding luminescence portions of received light from the object,

converting infrared light portions of the light in the first optical path into intensified light by image intensifying means,

providing photo detection means arranged for spatial imaging of the object, said photo detection means being arranged for alternately receiving light from the first and the second optical path,

providing processing means operably connected to the photo detection means, said processing means being adapted to obtain a spatial temperature image of the object from the intensified light of the first optical path, and

combining, at least partly, said temperature image with a luminescence image of the object obtained from the second optical path so as to obtain a combined image of the object.

The first, second and third aspect of the present invention may each be combined with any of the other aspects. These and other aspects of the invention will be apparent from and elucidated with reference to the embodiments described hereinafter.

### BRIEF DESCRIPTION OF THE FIGURES

The present invention will now be explained, by way of example only, with reference to the accompanying figures, where

FIG. 1 is a schematic drawing of the imaging apparatus according to the present invention,

FIG. 2 is a flow chart of the light, processed light and resulting images thereof,

FIG. 3 shows a diagram of how the temperature image is combined with a luminescence image,

FIG. 4 is a schematic drawing of an embodiment with displaceable mirrors,

FIG. 5 is a schematic drawing of an embodiment with an optical component for separating the first and second optical path,

FIG. 6 is an example of a fluorescence image obtained from a bio-array,

FIG. 7 is a plot of the differential intensity versus the absolute temperature, and

FIG. 8 is a flow chart of a method according to the invention.

### DETAILED DESCRIPTION OF AN EMBODIMENT

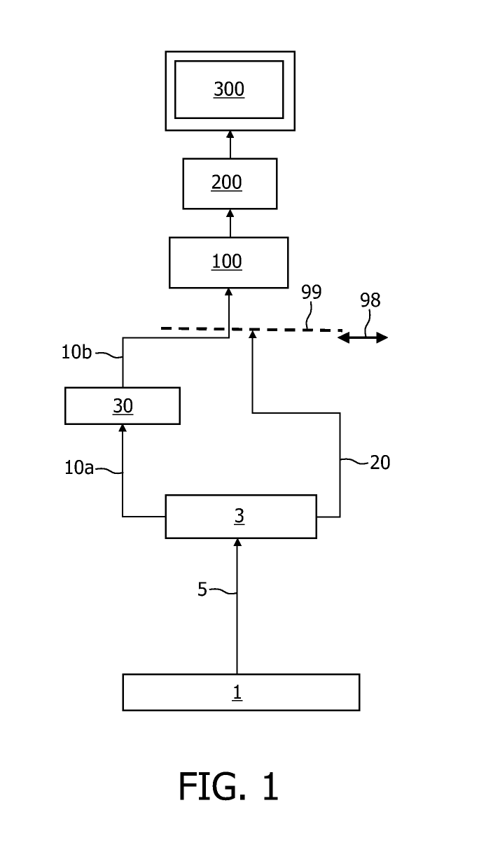

FIG. 1 is a schematic and simplified drawing of the imaging apparatus for obtaining a combined temperature and luminescence spatial image of an associated object 1 according to the present invention. The object 1 is situated in the lower part of FIG. 1 and emits light 5 that is received by optical separating means 3. The separating means 3 is arranged for separating the light 5 received from the object 1 into a first optical path 10 (to the left in FIG. 1) and a second optical path 20 (to the right in FIG. 1). The first optical path 10 is arranged for guiding infrared (IR) portions of the received light 5 from the object 1, whereas the second optical path 20 is arranged for guiding luminescence portions of received light 5 from the object 1.

Within the first optical path 10 there are positioned image intensifying means 30. The image intensifying means 30 are capable of converting infrared (IR) light portions 10a of the light in the first optical path 10 into intensified light 10b.

An image intensifier 30 that serves as a wavelength down-converter translating infrared light into light that can be detected by e.g. a dedicated CCD-camera is described in J. Wilson, and J. F. B. Hawkes, “Optoelectronics: An introduction,” Prentice-Hall, 2^{nd} edition, 1989. A possible configuration comprises a photo cathode that converts the infrared radiation into electrons, a phosphor screen (which also acts as anode) that converts the electrons generated into visible radiation, and one or more electrostatic focusing elements that ensure that electrons released from a certain spot at the photo cathode are focused on a corresponding spot at the photo cathode. Finally, a potential difference between the photo cathode and the anode/phosphor screen is applied in order to accelerate the electrons towards the phosphor screen.

Furthermore, the imaging apparatus according to the invention comprises photo detection means 100 arranged for spatial imaging of the object. The photo detection means 100 are more specifically arranged for alternately receiving light from the first 10 and the second 20 optical path. Thus, either light is received from the first 10 or the second 20 optical path. This is schematically indicated by the broken line 99 blocking, as shown in FIG. 1, the second optical path 20 and allowing light 10b of the first optical path 10 to pass. Similarly, the photo detection means 100 may be switched to another configuration so that the second optical path 20 is allowed to pass into the detection means 100 and the first optical path 10 is blocked relative to the detection means 100. This is illustrated by the double-arrow 98 next to the broken line 99.

The imaging apparatus according to the invention comprises processing 200 means operably connected to the photo detection means 100. The processing means 200 is adapted to obtain a spatial temperature image 11 of the object 1 from the intensified light 10b of the first optical path 10. The processing means 200 is further adapted to spatially combine, at least partly, said temperature image 11 with a luminescence image 21 of the object 1 obtained from the second optical path 20. The combined image (not shown in FIG. 1) may be displayed on an appropriate screen 300 connected to the processing means 200.

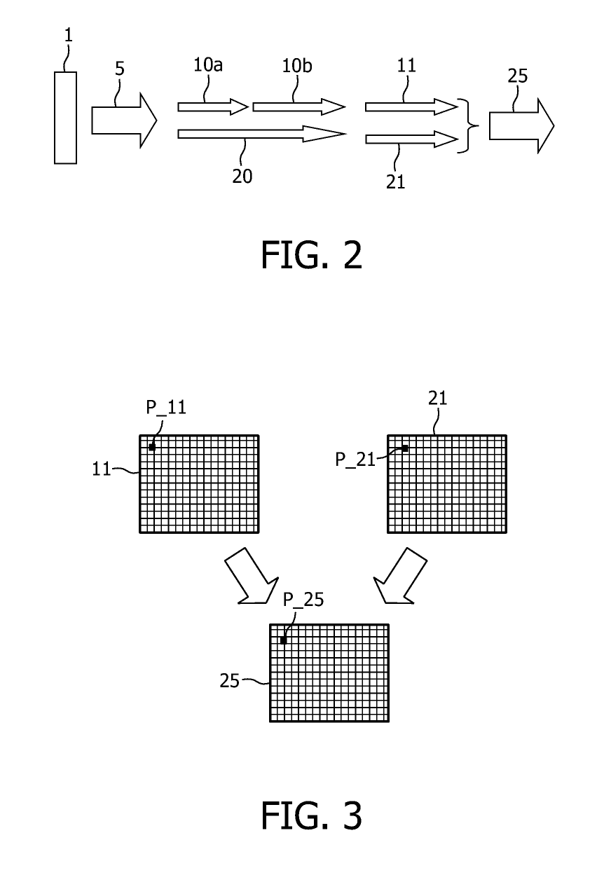

FIG. 2 is a flow chart of the light 5 emitted from the object 1, processed light 10 and 20 and resulting images 11, 21 and 25 thereof. The object 1 emits light 5 that is separated into two paths 10 and 20. The first path 10 comprises an infrared portion 10a which is processed by image intensifying means 30 (not shown in FIG. 2) into intensified light 10b that is further processed by the photo detection means and the processing means (neither are shown in FIG. 2) into a spatial temperature image 11 of the object 1. In the second optical path 20 the luminescence light portion of the light 5 received from the object 1 is guided to the photo detection means so as to obtain a spatial luminescence image 21 of the object 1. Finally, the spatial temperature image 11 of the object 1 and the spatial fluorescent image 21 of the object 1 are combined into an image 25.

FIG. 3 shows a diagram of how a temperature image 11 and a luminescence image 21 is combined in an embodiment of the present invention. The two images 11 and 21 are combined into a new image 25 containing information from both images 11 and 21. This may be done in many different ways as will be readily appreciated by the skilled person in image analysis.

In the embodiment shown in FIG. 3, the images 11, 21, and 25 are illustrated by two-dimensional arrays of pixels. For each image 11, 21, or 25 identically positioned pixels in the array comprise information P_{—11, P}_21 or P_25, respectively, originating from the same spatial position of the object 1. This is possible because the photo detection means 100 alternately receives light from the first 10 and second 20 optical path enabling inherent spatial correspondence between the images 11 and 21 obtained of object 1. Needless to say, this of course requires appropriate optical alignment of the first 10 and second 20 optical path relative to the object 1 and photo detection means 100. Thereby the present invention, in an easy and straightforward manner, facilitates temperature and luminescence data to be analyzed and/or presented. For practical implementation the arrays of pixels could be constituted by the pixels of a CCD, and accordingly the number of pixels may be in the order of millions or even higher. The object 1 for imaging may be a bio-array having dimensions of 1, 5, 20, 50 or 100 micrometers, or alternatively higher; 1, 2, 3, 4, 5, 6, 7, 8 or 10 mm. The number of different spots with distinct hybridization characteristics on such a bio-array may vary from around 10 to 1000 per mm² on current arrays, and even higher, e.g. up to 10,000 or 100,000 spots per mm². Within a spot on the array identical probe molecules are immobilized. Probe molecule density within a spot may be in the interval from 10 to 10̂(+10)/(micrometers)², preferably 10̂(+3) to 10̂(+8)/(micrometers)², or more preferably 10̂(+5) to 10̂(+7)/(micrometers)².

In one embodiment, discriminative levels may be set for the combined image 25. For example only pixels P_11 indicating that the local temperature is above a certain level associated with a specific hybridization or binding event may be transferred to the image 25. Alternatively or additionally, only pixels P_21 indicating that the luminescence level is above a certain level corresponding to a specific hybridization or bonding event may be transferred to the image 25. Using discriminative levels in the combination of the two images 11 and 21 may result in discarding selected parts of one and/or both images 11 and 21, and accordingly the combination of the two images may be understood to be partly within the context of the present invention. Similarly, parts of image 11 or 21 may be discarded beforehand if no relevant information is expected from these parts of an image.

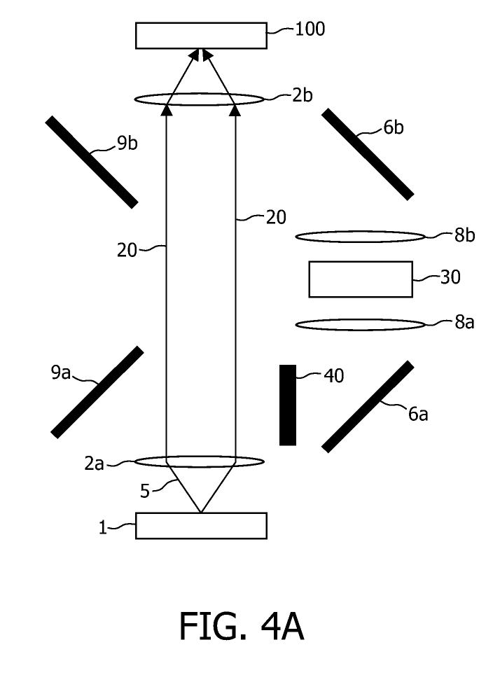

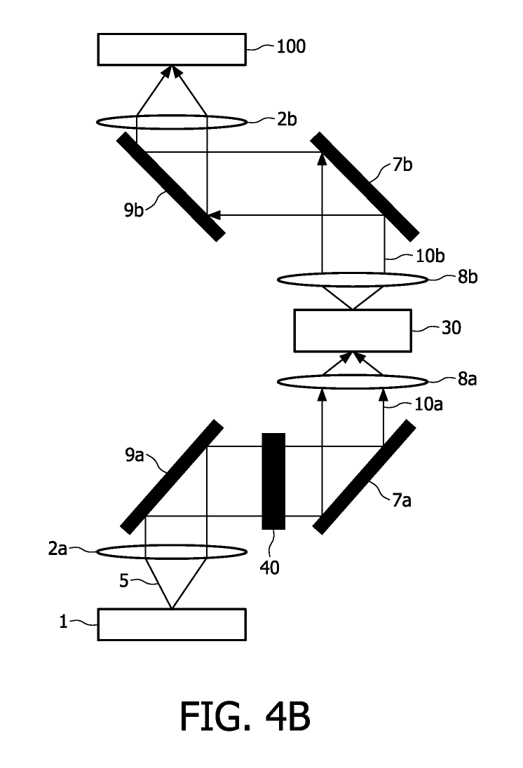

FIG. 4 is a schematic drawing of an embodiment of the imaging apparatus with displaceable mirrors 9. The displaceable mirrors 9a and 9b are displaceable to a first position shown in FIG. 4B for guiding the light received from the object 1 into the first optical path 10, and a second position shown in FIG. 4A for allowing the light 5 received from the object 1 into the second optical path 20.

In FIG. 4A, the light 5 from the object 1 is collimated by an appropriate lens 2a. Similarly, in the second optical path 20 the light is focused by a focusing lens 2b ensuring correct imaging of the object 1. Well known optical optimization measures such as focusing, collimating, alignment, etc. may be implemented in the imaging apparatus. Mirrors 6 and 9, band pass filter (BPF) 40, lenses 8 and image intensifying means 30 are shown in FIG. 4A, but they are not active in this configuration as the displaceable mirrors 9 are displaced to a non-active position with respect to the light 5 received from the object 1.

In FIG. 4B, the pair of displaceable mirrors 9a and 9b is displaced to a position where the light 5 received from the object 1 impinges on the mirror 9a. The mirrors 9a and 9b may be rotatably displaced from the position shown in FIG. 4A to the position shown in FIG. 4B. Alternatively, the mirrors 9a and 9b may linearly displaced, and possibly a combination of linear and rotational translation may be undertaken. The period between the two mirror positions shown in FIG. 4A and FIG. 4B may depend on the desired resolution and/or accuracy of the images obtained. The said period is typically in the order of seconds (e.g. 2, 4, 6 seconds), but longer or shorter periods may also be implemented in an imaging apparatus according to the present invention.

The light 5 reflected from the mirror 9a is guided to an optical band pass filter (BPF) 40 allowing only a selected portion of infrared (IR) light 10a to pass. The band pass range of the filter 40 could be 1-12 micrometers, preferably 1-11 micrometers or more preferably 3-7 micrometers. In an embodiment to be further explained below two wavelength intervals are utilized to determine the temperature. The filter 40 may then have a variable band pass range, or alternatively two or more filters may be interchangeably positioned in the first optical path 10. Optical band pass filters (BPF) are well known in the art and may include filters (e.g. color or interference), monochromators, interferometers (e.g. Fabry-Perot etalons).

After passing the filter 40 the infrared 10a light is guided to the image intensifying means 30 via mirror 7a and lens 8a. The image intensifying means 30 is capable of wavelength down-converting the infrared (IR) light 10a. Preferably, the image intensifying means 30 is capable of converting the infrared (IR) light into visible light 10b. Upon exit from image intensifying means 30 the light 10b is collimated by a lens 8b. Via mirrors 7b and 9b and through lens 2b, the light 10b is directed to the photo detection means 100.

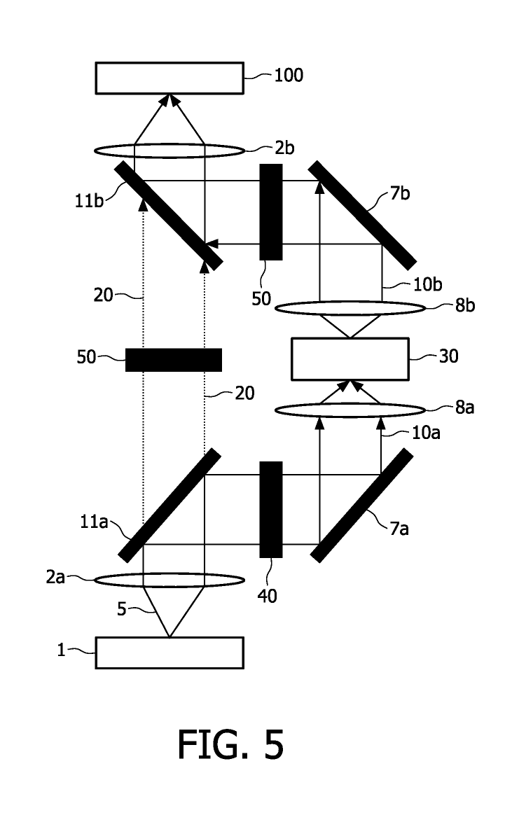

FIG. 5 is a schematic drawing of another embodiment of the imaging apparatus with two optical components 11a and 11b, i.e. dichromatic mirrors for separating the first 10 and second optical path 20. The optical configuration of FIG. 5 is similar to the configuration of FIG. 4, but instead of having displaceable mirrors the optical components 11 provide the separation into a first 10 and second 20 optical path without the need for any significant mechanical translation of the optical component itself. This functionality can be provided by a range of optical components including, but not limited to, dichromatic mirrors, gratings, prisms, holograms, etc. Shutters 50 are provided in the embodiment of FIG. 5 to ensure that the photo detection means 100 is alternately exposed to light from the first optical path 10 and the second optical path 20. Thus, the shutter 50 in the first optical path 10 is open when the shutter 50 in the second optical path 20 is closed, and vice-versa.

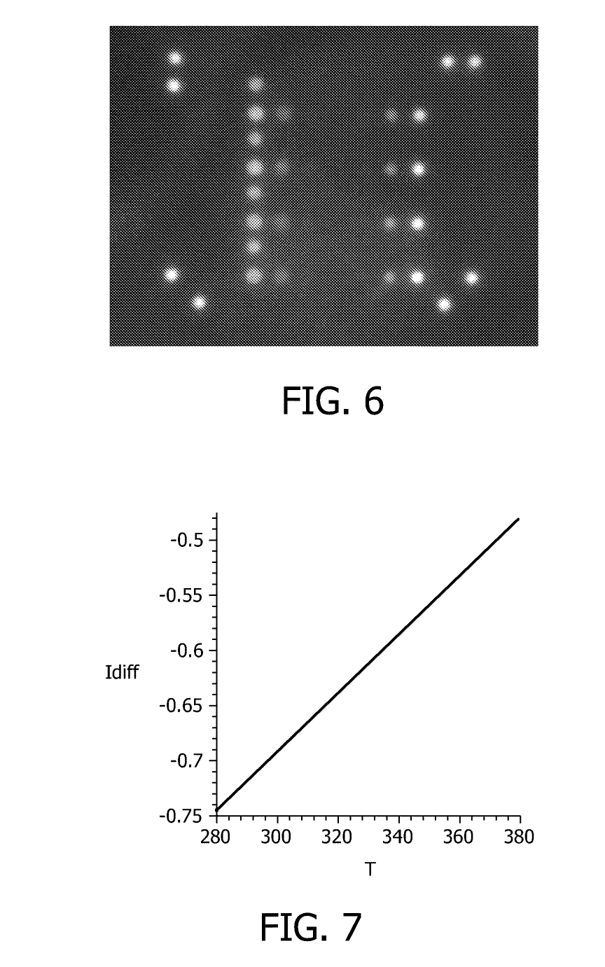

FIG. 6 is an example of a fluorescence image 21 obtained from a bio-array. The different spots are clearly visible so that identification of selected fluorescent sites on the array is possible and also relative differences in the level of emitted fluorescent light are evident in this image. The spots are approximately 200 micrometers in diameter. Fluorescent agents or labels have gained widespread use for hybridization detection on bio-arrays due to their reliable function and safe laboratory conditions as compared to e.g. radioactive labeling of biological molecules. Large biological molecules can be modified with a fluorescent chemical agent such as ethidium bromide. The fluorescence of this “tag” therefore provides for a very sensitive detection of the desired molecule. An appropriate lamp functions as excitation source, e.g. in the UV.

On a typical bio-array, the number of binding events per unit area is a measure of the concentration of targeted molecules in the sample solution of for example a blood sample. For the binding/hybridization kinetics the temperature is a quite important parameter. Accurate temperature control may increase the selectivity of the binding event, and therefore increase the prediction accuracy of the target molecule concentration in the sample. Accurate and local measurement of the temperature is accordingly a highly important parameter for proper interpretation of the number of targeted molecules in a test sample.

The local temperature on the binding site on a bio-array could be measured by imaging the area of the bio-array on an infrared camera. A standard IR camera measures radiation intensity integrated over a certain wavelength range. An application of IR thermography for that purpose in the area of bio-arrays may be found in US Patent Application 2004/0180369.

Although this approach provides very accurate relative temperature measurements within one image (typically 0.05 C.°) it may lack the accuracy in the absolute temperature values (typically +/−2 C.° or +/−2% of the value). This error in the absolute temperature value is mainly determined by emissivity of an object and losses which occur in the optical imaging system.

Let I_{eff}(λ₁,λ₂)=αI(λ₁,λ₂) be the total radiation detected by the detection means 100 in the wave range between λ₁ and λ₂. α is a coefficient which incorporates emmisivity of the object 1 and losses in the imaging system. It may be assumed that α does not depend on the wavelength. This is a common approximation, see for example EP 0 387 682 where this approximation is utilized.

Accordingly, it may be advantageous to detect the radiation energy from two wavelength regions or intervals. Technically this is done by measuring the energy with two different band-pass filters 40.

I_{eff1}(λ₁,λ₂)=αI(λ₁,λ₂)

I_{eff2}(λ₂,λ₃)=αI₂(λ₂,λ₃)

From these two images the slope of the emission curve, i.e. the differential intensity at each point of the image 11, can be calculated:

$$\begin{matrix}{I}_{diff} = \frac{{I}_{eff 1} - {I}_{eff 2}}{{I}_{eff 1} + {I}_{eff 2}} \\ = \frac{α {I}_{1} ( {λ}_{1} , {λ}_{2} ) - α {I}_{2} ( {λ}_{2} , {λ}_{3} )}{α {I}_{1} ( {λ}_{1} , {λ}_{2} ) + α {I}_{2} ( {λ}_{2} , {λ}_{3} )} \\ = \frac{{I}_{1} ( {λ}_{1} , {λ}_{2} ) - {I}_{2} ( {λ}_{2} , {λ}_{3} )}{{I}_{1} ( {λ}_{1} , {λ}_{2} ) + {I}_{2} ( {λ}_{2} , {λ}_{3} )}\end{matrix}$$

As is evident, this expression does not depend on the emissivity of the object 1 and on losses in the optical system. This gives an advantage as this method does not require calibration for different types of materials with different emissivities and losses in the system.

FIG. 7 shows the absolute temperature (deg. Kelvin) dependence of the differential intensity, I_{diff}. For λ₁, λ₂, and λ₃ wavelengths of 3 micrometers, 5 micrometers and 7 micrometers, respectively, have been found to yield a substantially linear response on the temperature. This is evident from FIG. 7, where the temperature response is substantially linear. This is also advantageous over some conventional methods as the calibration of the system could be performed by only two measurements. Alternatively, λ₁, λ₂ and λ₃ may be set to 2 micrometers, 4 micrometers and 6 micrometers, respectively, or 4 micrometers, 6 micrometers and 8 micrometers, respectively. Both options yield a close or substantially linear response. The width of the two wavelength intervals may also be set to 0.5 micrometers, 1 micrometers, or 1.5 micrometers depending on the imaging apparatus according to the present invention.

The temperature sensitivity of this differential method is three times lower than the conventional one. So upon the temperature change of 0.1 degree a differential signal of 0.2*10̂(−3) is achieved. However, this is still above the noise level of a typical IR image camera and could be easily detected. Also, the absolute value of the measured signals is approximately five times lower meaning that integration time should be longer. This is not a problem as temperature measurement could be performed with low frequency in most bio-array applications.

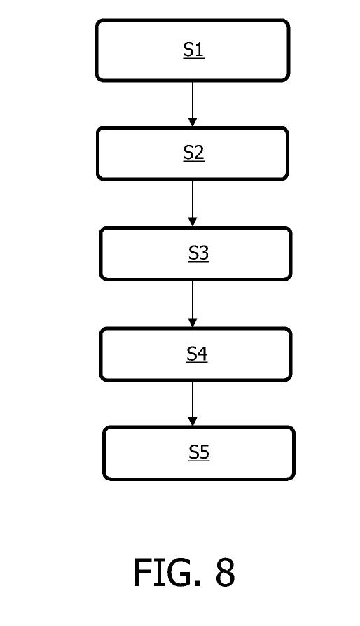

FIG. 8 is a flow chart of a method according to the invention. The method for obtaining a combined temperature and luminescence spatial image 25 of an object 1 comprises the steps of:

S1: separating light 5 received from the object 1 into a first 10 and a second 20 optical path, said first optical path 10 being arranged for guiding infrared (IR) portions of the received light from the object, said second optical path 20 being arranged for guiding luminescence portions of received light 5 from the object 1,

S2: converting infrared light portions 10a of the light in the first optical path into intensified light 10b by image intensifying means 30,

S3: providing photo detection means 100 arranged for spatial imaging of the object 1, said photo detection means being arranged for alternately receiving light from the first 10 and the second 20 optical path,

S4: providing processing means 200 operably connected to the photo detection means 100, said processing means being adapted to obtain a spatial temperature image 11 of the object from the intensified light 10b of the first optical path 10, and

S5: combining, at least partly, said temperature image 11 with a luminescence image 21 of the object 1 obtained from the second optical path 20 so as to obtain a combined image 25 of the object.

Although the present invention has been described in connection with the specified embodiments, it is not intended to be limited to the specific form set forth herein. Rather, the scope of the present invention is limited only by the accompanying claims. In the claims, the term “comprising” does not exclude the presence of other elements or steps. Additionally, although individual features may be included in different claims, these may possibly be advantageously combined, and the inclusion in different claims does not imply that a combination of features is not feasible and/or advantageous. In addition, singular references do not exclude a plurality. Thus, references to “a”, “an”, “first”, “second” etc. do not preclude a plurality. Furthermore, reference signs in the claims shall not be construed as limiting the scope.

1. An imaging apparatus for obtaining a combined temperature and luminescence spatial image (25) of an associated object (1), the apparatus comprising:
optical separating means (3, 9, 11) for separating light (5) received from the object into a first (10) and a second (20) optical path, said first optical path (10) arranged for guiding infrared (IR) portions of the received light from the object, said second optical path (20) being arranged for guiding luminescence portions of received light from the object,
image intensifying means (30) capable of converting infrared light portions of the light (10a) in the first optical path into intensified light (10b),
photo detection means (100) arranged for spatial imaging of the object (1), said photo detection means being arranged for alternately receiving light from the first (10) and the second (20) optical path, and
processing means (200) operably connected to the photo detection means (100), said processing means being adapted to obtain a spatial temperature image (11) of the object from the intensified light (10b) of the first optical path, said processing means further being adapted to spatially combine at least partly said temperature image (11) with a luminescence image (21) of the object obtained from the second optical path (20) so as to obtain a combined image (25) of the object.

2. An apparatus according to claim 1, wherein said combined image (25) of the object comprises luminescence data and temperature data about the object (1).

3. An apparatus according to claim 1, wherein the luminescence portion of received light (5) from the object comprises light selected from the group consisting of: photoluminescence, electroluminescence, chemiluminescence and bioluminescence.

4. An apparatus according to claim 1, wherein the photoluminescence portion of received light (5) from the object comprises light selected from the group consisting of: fluorescence and phosphorescence.

5. An apparatus according to claim 1, wherein the photo detection means (100) is a single photo detection entity (100) so to as provide a direct spatial correspondence between the temperature image (11) and luminescence image (21) obtained of the object (1).

6. An apparatus according to claim 1, wherein the photo detection means (100) comprises a charge coupled device (CCD).

7. An apparatus according to claim 1, wherein the optical separating means (9) comprises at least one displaceable mirror.

8. An apparatus according to claim 7, wherein at least one displaceable mirror (9a, 9b) is displaceable to a first position for guiding the light (5) received from the object into the first optical path (10), and a second position for guiding the light (5) received from the object into the second optical path (20).

9. An apparatus according to claim 1, wherein the optical separating means (11) comprises at least one optical component capable of splitting the light received from the object into an infrared (IR) portion and a luminescence portion, and redirecting the two portions into the first (10) and the second (20) optical path, respectively.

10. An apparatus according to claim 1, wherein the image intensifying means (30) is capable of wavelength down-converting the infrared (IR) light.

11. An apparatus according to claim 1, wherein the image intensifying means (30) is capable of converting the infrared (IR) light into visible light (VIS).

12. An apparatus according to claim 1, wherein the first optical path (10) comprises one or more optical band-pass filters (40).

13. An apparatus according to claim 1, wherein the first optical path comprises at least a first and a second optical band-pass filter (40), said first and second band-pass filter having different band-pass ranges, preferably non-overlapping band-pass ranges.

14. An apparatus according to claim 13, wherein the temperature spatial image (11) is obtained by combining data obtained from light having passed said first optical band-pass filter (40) with data obtained from light having passed said second optical band-pass filter (40).

15. An apparatus according to claim 1, wherein the object (1) for imaging is a bio-array.

16. An apparatus according to claim 15, where the bio-array comprises a plurality of spots, wherein probe molecules are immobilized.

17. A biological detection system for detecting the presence, and optionally quantity, of one or more biological targets, said system comprising an imaging apparatus according to claim 1.

18. A method for obtaining a combined temperature and luminescence spatial image of an object (1), the method comprising the steps of:
separating light (5) received from the object (1) into a first (10) and a second (20) optical path, said first optical path (10) being arranged for guiding infrared (IR) portions of the received light from the object, said second optical path (20) being arranged for guiding luminescence portions of received light (5) from the object (1),
converting infrared light portions (10a) of the light in the first optical path into intensified light (10b) by image intensifying means (30),
providing photo detection means (100) arranged for spatial imaging of the object (1), said photo detection means being arranged for alternately receiving light from the first (10) and the second (20) optical path,
providing processing means (200) operably connected to the photo detection means (100), said processing means being adapted to obtain a spatial temperature image (11) of the object from the intensified light (10b) of the first optical path (10), and
combining, at least partly, said temperature image (11) with a luminescence image (21) of the object (1) obtained from the second optical path (20) so as to obtain a combined image (25) of the object.
